(19) United States
(12) Patent Application Publication
(10) Pub. No.: US 2008/0133238 A1
(43) Pub. Date: Jun. 5, 2008

(54) INFORMATION PROCESSING APPARATUS AND INFORMATION PROCESSING METHOD

(75) Inventors: Hiroki Yamamoto, Yokohama-shi (JP); Kouhei Awaya, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/948,621

(22) Filed: Nov. 30, 2007

(30) Foreign Application Priority Data
Dec. 5, 2006 (JP) 2006-328206

(51) Int. Cl. G10L 15/00; G06F 17/30

(52) U.S. Cl. 704/251; 707/3; 707/E17.014; 704/E15.001

(57) ABSTRACT

Some embodiments of the present invention include an information processing apparatus comprising a setting unit configured to set first retrieval criteria including a plurality of items; a storage unit configured to store a designated word in relation to the first retrieval criteria set by the setting unit, into a memory; and a retrieval unit configured to receive a speech input including the word stored in relation to the first retrieval criteria and second retrieval criteria different from the first retrieval criteria, and retrieve data based on both the first retrieval criteria and the second retrieval criteria.

### BACKGROUND OF THE INVENTION

1. Field of the Invention

The present invention relates to an information processing apparatus configured to retrieve registered information.

2. Description of the Related Art

A conventional WEB browser enables a user to retrieve information from various sites accessible via Internet and register a retrieval result using a bookmark. The WEB browser stores retrieval criteria together with a registered bookmark name and, if a user invokes the bookmark, displays the same retrieval result reflecting the previously applied retrieval criteria.

As discussed in Japanese Patent Application Laid-Open No. 11-184670, a conventional network access system can invoke a registered bookmark in response to a speech input. The network access system according to the Japanese Patent Application Laid-Open No. 11-184670 registers a uniform resource locator (URL) in relation to the input speech and, if the same speech input is received, accesses the URL relating to the input speech.

The conventional system discussed in Japanese Patent Application Laid-Open No. 11-184670 allows a user to invoke a desired bookmark by speech input. However, a user cannot input any additional retrieval criteria or additional information together with an invoked bookmark or invoked retrieval criteria.

### SUMMARY OF THE INVENTION

Exemplary embodiments of the present invention are directed to an information processing apparatus configured to enable a user to input additional retrieval criteria when a user invokes a retrieval result screen or a retrieval criteria input screen by speech input.

According to an aspect of the present invention, an information processing apparatus includes a setting unit configured to set first retrieval criteria including a plurality of items, a storage unit configured to store a designated word in relation to the first retrieval criteria set by the setting unit, into a memory, and a retrieval unit configured to receive a speech input including the word stored in relation to the first retrieval criteria and second retrieval criteria different from the first retrieval criteria and retrieve data based on both the first retrieval criteria and the second retrieval criteria.

According to another aspect of the present invention, an information processing apparatus includes a first display control unit configured to display on a screen display data that enable a user to set retrieval criteria including a plurality of items, a focus control unit configured to focus the display of the screen on at least one of the plurality of items, a setting unit configured to set the retrieval criteria including the plurality of items, a register unit configured to register a designated word in relation to the retrieval criteria set by the setting unit wherein the register unit relates the word with an item focused by the focus unit, a receiving unit configured to receive designation of the word, and a second display control unit configured to display on a screen display data setting the retrieval criteria related to the word in response to the designation of the word received by the receiving unit, in a condition where an item relating to the word registered by the register unit is focused.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 illustrates an information processing apparatus according to a first exemplary embodiment of the present invention.

FIG. 2 illustrates an example of program information to be processed by the information processing apparatus according to the first exemplary embodiment of the present invention.

FIG. 3 illustrates one of the screens displayed by the information processing apparatus according to the first exemplary embodiment of the present invention.

FIG. 4 illustrates an exemplary operation performed by the information processing apparatus according to the first exemplary embodiment of the present invention.

FIG. 5 illustrates an exemplary operation performed by the information processing apparatus according to the first exemplary embodiment of the present invention.

FIG. 6 illustrates an example of screen control information to be processed by the information processing apparatus according to the first exemplary embodiment of the present invention.

FIG. 7 illustrates an exemplary speech recognition grammar to be processed by the information processing apparatus according to the first exemplary embodiment of the present invention.

FIG. 8 is a flowchart illustrating a processing procedure of a bookmark registration operation performed by the information processing apparatus according to the first exemplary embodiment of the present invention.

FIG. 9 illustrates an exemplary operation performed by the information processing apparatus according to the first exemplary embodiment of the present invention.

FIG. 10 illustrates an exemplary tag for a word to be recognized used in the information processing apparatus according to the first exemplary embodiment of the present invention.

FIG. 11 is a flowchart illustrating a processing procedure of a bookmark invocation operation performed by the information processing apparatus according to the first exemplary embodiment of the present invention.

FIG. 12 illustrates one of screens displayed by the information processing apparatus according to the first exemplary embodiment of the present invention.

FIG. 13 illustrates an information processing apparatus according to a second exemplary embodiment of the present invention.

FIG. 14 illustrates an exemplary operation performed by the information processing apparatus according to the second exemplary embodiment of the present invention.

FIG. 15 illustrates an example of screen control information to be processed by the information processing apparatus according to the second exemplary embodiment of the present invention.

FIG. 16 is a flowchart illustrating a processing procedure of a bookmark registration operation performed by the information processing apparatus according to the second exemplary embodiment of the present invention.

FIG. 17 is a flowchart illustrating a processing procedure of a bookmark invocation operation performed by the information processing apparatus according to the second exemplary embodiment of the present invention.

FIG. 18 illustrates one of screens displayed by the information processing apparatus according to a third exemplary embodiment of the present invention.

FIG. 19 illustrates an example of screen control information to be processed by the information processing apparatus according to the third exemplary embodiment of the present invention.

FIG. 20 is a flowchart illustrating a processing procedure of a bookmark registration operation performed by the information processing apparatus according to the third exemplary embodiment of the present invention.

FIG. 21 illustrates one of screens displayed by the information processing apparatus according to the third exemplary embodiment of the present invention.

### DETAILED DESCRIPTION OF THE EMBODIMENTS

The following description of exemplary embodiments is illustrative in nature and is in no way intended to limit the invention, its application, or uses. Processes, techniques, apparatus, and systems as known by one of ordinary skill in the art are intended to be part of the enabling description where appropriate. It is noted that throughout the specification, similar reference numerals and letters refer to similar items in the following figures, and thus once an item is described in one figure, it may not be discussed for following figures. Exemplary embodiments of the present invention are described below with reference to the drawings.

### First Exemplary Embodiment

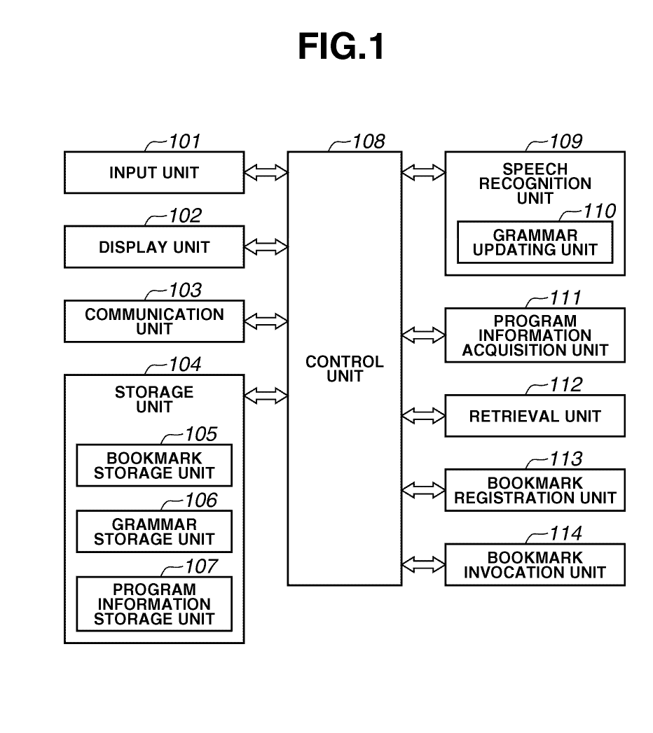

A first exemplary embodiment of the present invention relates to an information processing apparatus configured to perform program retrieval processing. FIG. 1 illustrates an information processing apparatus according to the first exemplary embodiment. The information processing apparatus includes an input unit 101, a display unit 102, a communication unit 103, a storage unit 104, a bookmark storage unit 105, a grammar storage unit 106, a program information storage unit 107, a control unit 108, a speech recognition unit 109, a grammar updating unit 110, a program information acquisition unit 111, a retrieval unit 112, a bookmark register unit 113, and a bookmark invocation unit 114.

The input unit 101 includes an input device (e.g., a group of buttons, a keyboard, a mouse, a touch panel, a pen, a tablet, and a digitizer) in addition to a microphone (speech inputting device) and analog-to-digital (A/D) converters. The input unit 101 can function as an input interface that can input various instructions to the control unit 108. The display unit 102 includes a liquid crystal display or other display device that can display various information including images and characters. The display unit 102 is, for example, a touch panel display device that may function as an input unit capable of inputting various instructions to the control unit 108.

The communication unit 103 is a broadcast wave receiving apparatus or a network apparatus accessible to a local area network (LAN) or Internet. The communication unit 103 communicates with an external apparatus when the program information acquisition unit 111 obtains program information. The storage unit 104 is a hard disk drive apparatus (HDD apparatus) capable of storing various information/data or a portable storage medium (e.g., compact disk read only memory (CD-ROM) or a digital versatile disk read only memory (DVD-ROM)) that supplies various information to an information processing apparatus. The HDD apparatus and the storage medium can store various application programs, user interface control programs, and various data required in executing various programs. The control unit 108 can read a required program and data from the HDD apparatus or the storage medium.

When the bookmark register unit 113 receives screen control information registered by a user, the bookmark storage unit 105 can store the received screen control information in relation to a bookmark name designated by the user. The grammar storage unit 106 stores a speech recognition grammar that describes grammar rules acceptable by the speech recognition unit 109. The program information storage unit 107 stores program information that the program information acquisition unit 111 obtains via the communication unit 103.

The control unit 108 includes a work memory and a central processing unit (CPU) or a micro processing unit (MPU) The control unit 108 reads a program or data from the storage unit 104 and executes various processing. The control unit 108 manages time information. For example, the retrieval unit 112 can refer to the time information when exclusively collecting program information broadcasted after finishing the retrieving operation. Furthermore, the program information acquisition unit 111 can obtain program information/data at predetermined intervals with reference to the time information.

The speech recognition unit 109 performs speech recognition processing on speech data input via the input unit 101 according to a speech recognition grammar stored in the grammar storage unit 106. The speech recognition is performed utilizing the known technique.

The grammar updating unit 110 generates an updated speech recognition grammar which includes grammar rules newly added to or modified from the speech recognition grammar stored in the grammar storage unit 106.

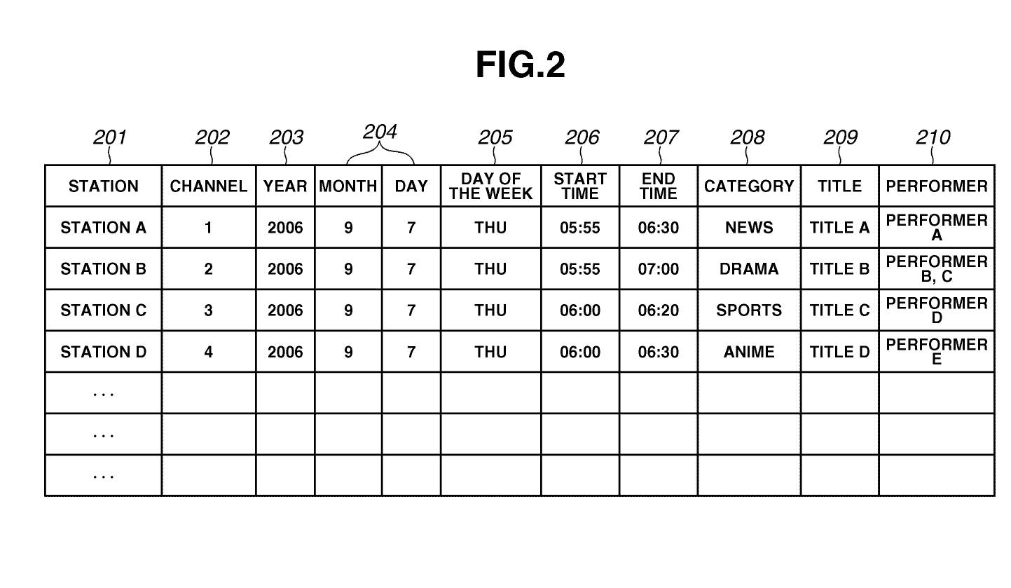

The program information acquisition unit 111 obtains program information from an external apparatus via the communication unit 103 and stores the obtained program information in the program information storage unit 107. FIG. 2 illustrates an example of program information that includes, for each program, station name 201, channel 202, broadcast schedule (year 203, month 204, day 204, and day of the week 205), start time 206, end time 207, category 208, title 209, and performer 210.

The program information illustrated in FIG. 2 can further include other information (e.g., sub title, sub category, detailed program content). Furthermore, the program information storage unit 107 can store information/data of a limited number of items processed by the information processing apparatus.

The retrieval unit 112 retrieves program information that accords with the retrieval criteria input or designated by a user. The display unit 102 displays the retrieved result. In an exemplary embodiment, the retrieval criteria include various types of information/data including keywords, texts, selected items, and conditional expressions used for a retrieval operation.

The bookmark register unit 113 stores screen control information designated by a user into the bookmark storage unit 105. If a user designates a display screen of the retrieval result, the bookmark storage unit 105 stores the designated retrieval criteria.

The bookmark invocation unit 114 reads, from the bookmark storage unit 105, screen control information relating to a bookmark name designated by a user. The display unit 102 performs screen display processing according to the read screen control information.

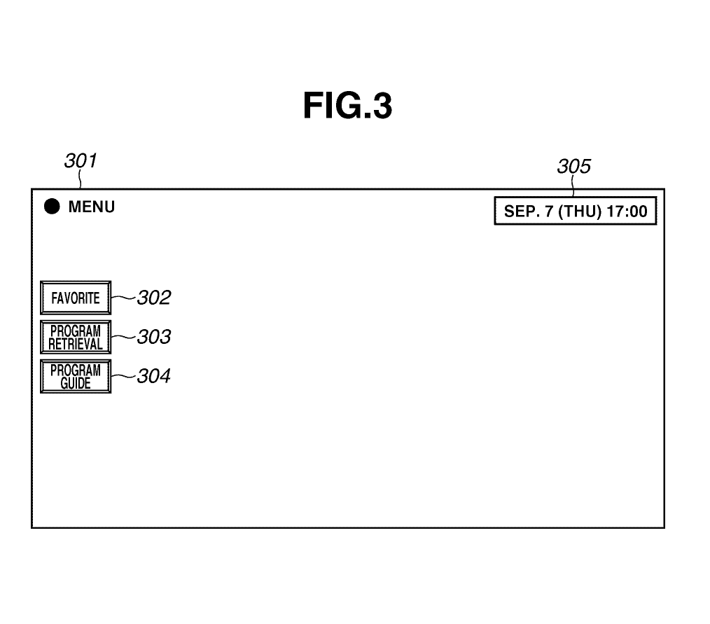

An exemplary operation performed by an information processing apparatus according to the first exemplary embodiment of the present invention is described below with reference to FIGS. 3 to 11.

FIG. 3 illustrates a menu screen 301 and graphical user interface (GUI) buttons 302-304 displayed on the display unit 102 when the information processing apparatus starts its operation. If a user presses a button using a pointing device (e.g., a mouse) of the input unit 101, the control unit 108 executes processing allocated to the button. If a user presses a favorite button 302, the display unit 102 displays a favorite menu that enables a user to register or invoke a bookmark. If a user presses a program retrieval button 303, the display unit 102 displays a screen that enables a user to input retrieval criteria of program information. If a user presses a program guide button 304, the display unit 102 displays a program guide. Furthermore, the menu screen 301 includes a date/time field 305 that displays time information managed by the control unit 108.

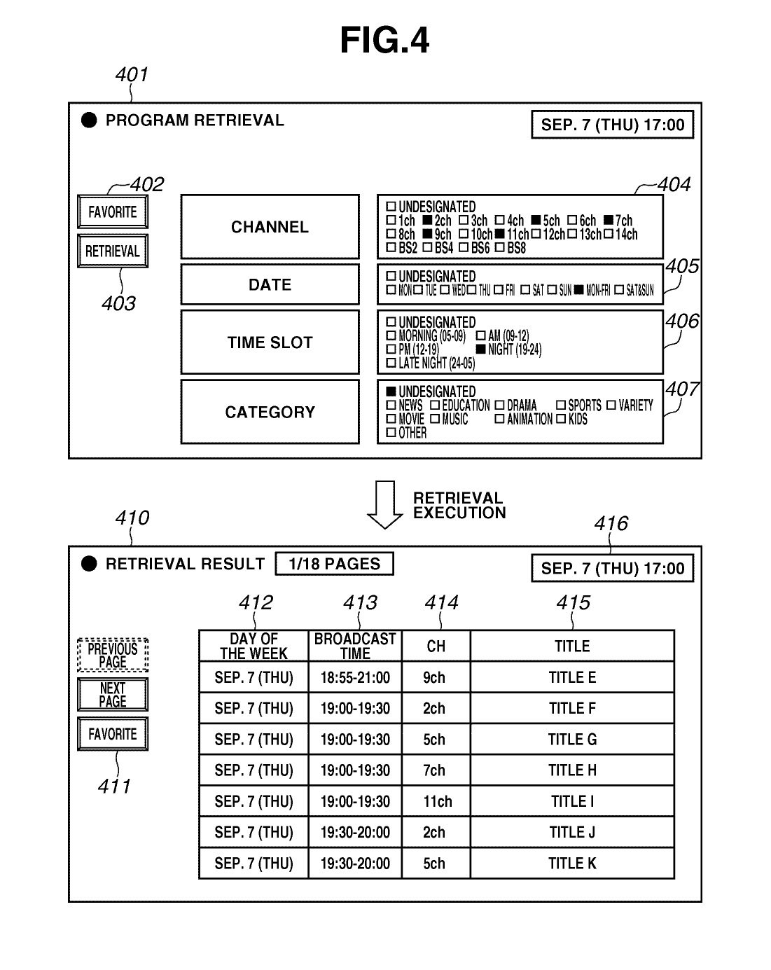

FIG. 4 illustrates an exemplary TV program retrieval operation performed by the information processing apparatus according to the first exemplary embodiment of the present invention. In FIG. 4, an exemplary screen 401 enables a user to input retrieval criteria, and an exemplary screen 410 displays a retrieval result.

When a user presses the program retrieval button 303 on the menu screen 301 illustrated in FIG. 3, the display unit 102 displays the retrieval criteria input screen 401. According to the information processing apparatus of the first exemplary embodiment, a user can designate retrieval criteria with respect to the items of channel (404), day of the week (405), time slot (406), and category (407).

A user can designate the retrieval criteria using a pointing device (e.g., a mouse or a digitizer). As another method for designating retrieval criteria, a user can operate a cursor key to move the focus point and press an enter key when a desired item/portion is focused. On the screen 401, any item blacked out in a check box indicates retrieval criteria designated by a user.

The following is designated retrieval criteria.

### Channel (404): 2ch, 5ch, 7ch, 9ch, and 11ch

### Day of the week (405): Mon-Fri

### Time slot (406): night (19-24)

### Category (407): undesignated.

Subsequently, if a user presses a retrieval button 403 through the input unit 101, the retrieval unit 112 retrieves and obtains program information which accords with the designated retrieval criteria from the program information storage unit 107. The display unit 102 displays a retrieval result being shaped in a predetermined pattern.

In an exemplary embodiment, the retrieval unit 112 retrieves only program information of programs being currently broadcasted or to be later broadcasted by referring to the time information managed by the control unit 108.

The retrieval result 410, displayed by the display unit 102, includes information relating to date (412), broadcast time (413), channel (414), and title (415) of a plurality of TV programs according to the order of broadcast start time. Another exemplary method may further include displaying the retrieval result for each channel or category.

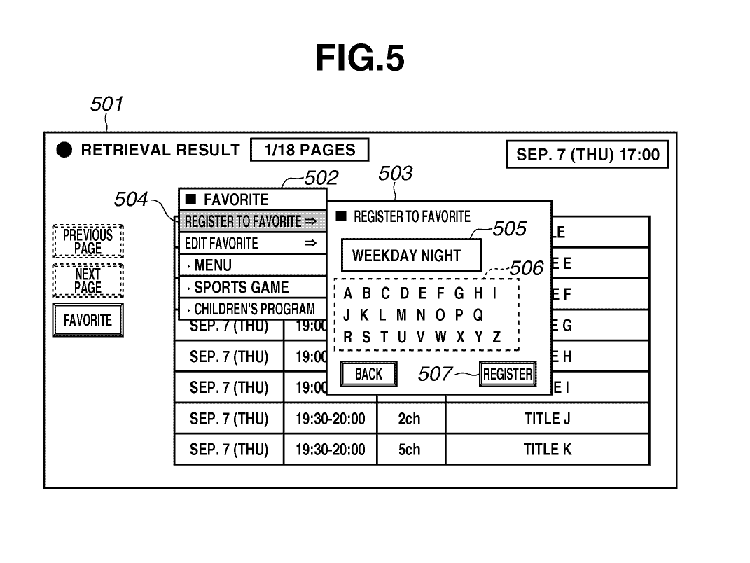

An exemplary bookmark registration operation for a retrieval result screen is described below. If a user instructs registering a bookmark on the retrieval result display screen (410 of FIG. 4), the bookmark register unit 113 stores control information of the currently displayed retrieval result screen into the bookmark storage unit 105. FIG. 5 illustrates an exemplary operation of the information processing apparatus according to the first exemplary embodiment which registers the retrieval result screen to a bookmark.

If a user presses a favorite button 411 on the retrieval result display screen (410 of FIG. 4), the display unit 102 displays a favorite menu (502). Furthermore, if a user selects “register to favorite” (504) on the menu (502), the display unit 102 displays a bookmark registration window (503).

Subsequently, a user inputs a bookmark name into the registration window 503, for example, using the keyboard or a software keypad 506. Alternatively, a user can input a bookmark name via the speech recognition unit 109. The bookmark name input by a user is displayed in a field 505. An input example of the bookmark name illustrated in FIG. 5 is “weekday night.”

A user can press a registration button 507 to finalize the input bookmark name and terminate the bookmark registration processing. In this case, the bookmark register unit 113 relates the control information of the retrieval result screen with the bookmark name input by a user and stores the related information/data into the bookmark storage unit 105. Furthermore, the grammar updating unit 110 updates the speech recognition grammar stored in the grammar storage unit 106 so that the speech recognition unit 109 can accept the bookmark name input by the user.

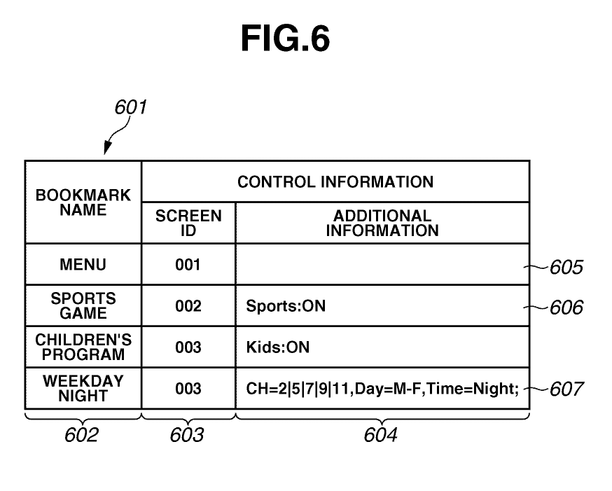

FIG. 6 illustrates exemplary contents 601 stored in the bookmark storage unit 105, according to which a bookmark name 602 is related with screen control information including a screen ID (603) and additional information (604).

The storage unit 104 stores the type of a graphical user interface (GUI) device (i.e., a screen displayed by the information processing apparatus) and the layout of the GUI device in relation to the screen ID for each screen. The display unit 102 controls a state of the screen with reference to the screen ID. According to an exemplary embodiment, the display unit 102 displays the menu screen (301 of FIG. 3) when the screen ID is 001, the retrieval criteria input screen (401 of FIG. 4) when the screen ID is 002, and the retrieval result display screen (410 of FIG. 4) when the screen ID is 003.

In addition to the above-described screen ID, a user can record additional information (604) as part of screen control information indicating a state of the GUI device, such as the presence of a check box selection, in a bookmark registration operation. For example, the screen control information relating to a bookmark “SportsGame” (row of 606) includes a screen ID “002” and additional information “Sports: ON.” In this case, the registered bookmark indicates a state of the retrieval criteria input screen that displays a black-out check box of “Sports” in the category. The screen control information relating to a bookmark “MENU” (row of 605) includes only screen ID “001” and is example of not having the additional information.

The additional information (604) stored in the registration of a retrieval result screen to a bookmark is retrieval criteria in a retrieving operation. The additional information in the row 607 is “CH=2|5|7|9|11, Day=M2F, Time=Night”, which represents retrieval criteria designated by a user on the above-described retrieval criteria input screen (401 of FIG. 4). More specifically, “CH=2|5|7|9|11” indicates that the channel is one of 2ch, 5ch, 7ch, 9ch, and 11ch. “Day=M-F” indicates that the day of the week is “Mon to Fri.” Furthermore, “Time=Night” indicates that the time slot is “night (19-24).” As illustrated in this example, nothing is recorded with respect to an item of category which is not designated as retrieval criteria.

An exemplary updating operation for a speech recognition grammar is performed when a bookmark is registered in the following manner. The grammar updating unit 110 reads a speech recognition grammar from the grammar storage unit 106, and updates the read speech recognition grammar so that the speech recognition unit 109 can accept a bookmark name input by a user. For example, the grammar updating unit 110 adds a word “menu” to the speech recognition grammar when a bookmark name “menu” is registered.

Furthermore, the grammar updating unit 110 updates the speech recognition grammar so that a bookmark name and additional retrieval criteria can be both input when a retrieval result screen is registered to a bookmark. For example, the grammar updating unit 110 updates the speech recognition grammar so that an input such as “oo at weekday night”, “drama and sport at weekday night”, and “channel 2 and channel 3 at weekday night” can be accepted when a bookmark name “weekday night” is registered. The grammar storage unit 106 stores the updated speech recognition grammar.

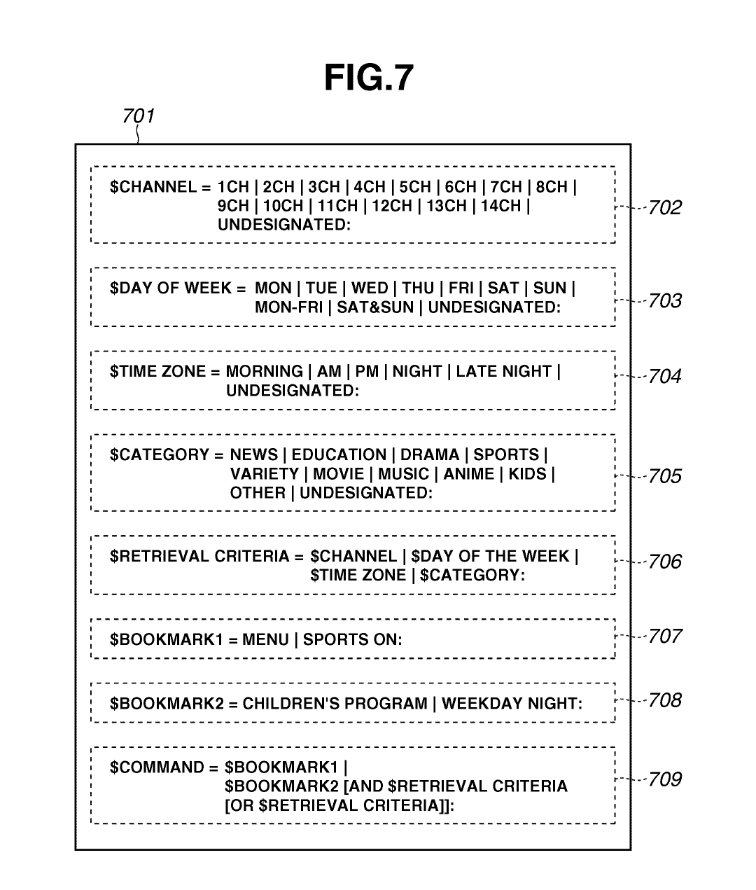

To simplify the speech recognition grammar update processing during a bookmark registration operation, the grammar updating unit 111 can use a template for updating the speech recognition grammar which is prepared beforehand. FIG. 7 illustrates an exemplary speech recognition template that describes contents of speech recognition grammar 701 according to a form similar to the publicly known Backus Naur Form (BNF) notation.

According to this form, the speech recognition grammar is described according to the following rules.

Expression of “rule name=right side;” defines each grammar rule.

Only the description of a defined rule name is preset in the left side.

“$” indicates a head of a rule name.

“;” indicates a tail of the definition of a rule.

Description of a defined rule is present in the right side.

“|” indicates OR.

The description in parentheses “[ ]” can be omitted.

The rule in the form of “$ command” is acceptable by the speech recognition unit 109.

The speech recognition grammar 701 includes a description of definition fields 702 to 709 according to the above-described rules. The field 702 defines that “$channel” is one of “1 channel”, “2 channel”, “3 channel” . . . , and “undesignated channel.” Namely, “$channel” defines any word designating retrieval criteria with respect to the channel.

Similarly, the fields 703, 704, and 705 define words to be used in the designation of retrieval criteria with respect to “day of the week”, “time slot”, and “category.” The field 706 defines that “$ retrieval criteria” is any word used in the designation of “channel”, “day of the week”, “time slot”, and “category.” The field 707 defines bookmark names not displayed on a retrieval result screen, and “$ bookmark 1” is any one of bookmark names not displayed on a retrieval result screen. Similarly, the filed 708 defines that “$ bookmark 2” is any one of bookmark names on a retrieval result screen.

The field 709 defines grammar rules that a speech recognition grammar 1001 finally accepts. The first row of the field 709 defines a bookmark name not displayed on the retrieval result screen, which can be accepted only as a single bookmark name. Two more retrieval criteria can be added if the retrieval result includes a bookmark name (“$ bookmark 2”) indicated in the second row of the field 709. Namely, there are three entry types of “oo and □□ at weekday night” (oo and □□ are selectable from the retrieval criteria), “oo at weekday night”, and “weekday night.”

If a template of the speech recognition grammar 701 is available, the grammar updating unit 110 can simply add a registered bookmark name to the field 707 or 708 in a bookmark registration operation. If the screen to be bookmarked is not a retrieval result screen, the grammar updating unit 110 adds a bookmark name to the field 707. If the screen to be bookmarked is a retrieval result screen, the grammar updating unit 110 adds a bookmark name to the field 708. As the rules described in the field 709 accept addition of retrieval criteria, it is unnecessary to update the rules relating to additional retrieval criteria in each registration of a bookmark.

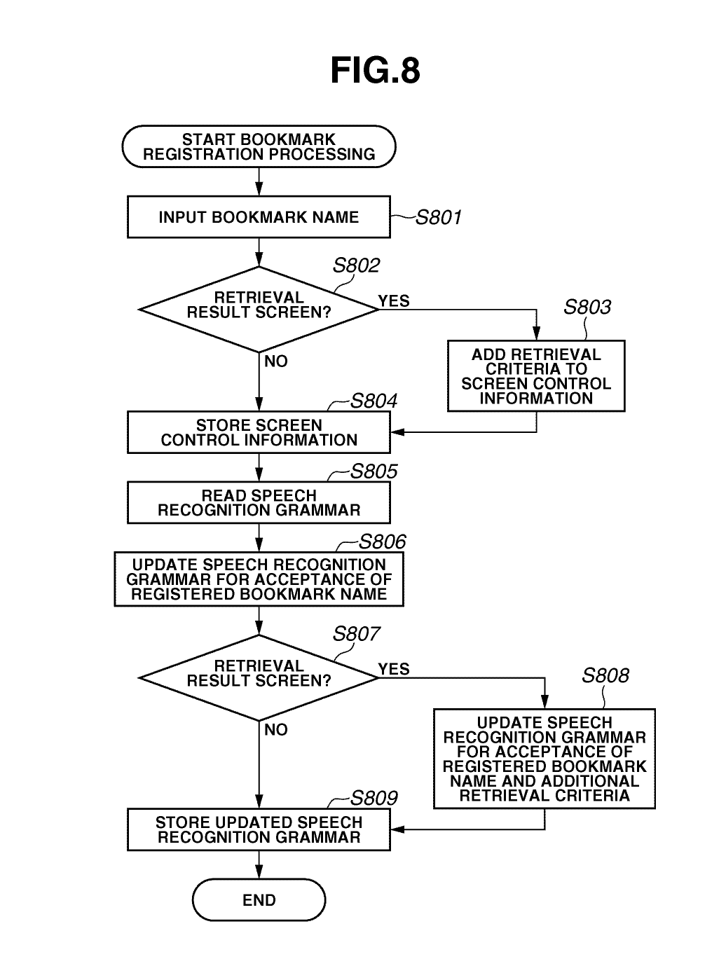

Exemplary bookmark registration processing is described below with reference to FIG. 8. FIG. 8 is a flowchart illustrating a processing procedure of a bookmark registration operation performed by the information processing apparatus according to the first exemplary embodiment of the present invention.

In step S801, a user inputs a bookmark name via the input unit 101. In step S802, it is determined whether the screen to be bookmarked is a retrieval result screen. If the screen to be bookmarked is the retrieval result screen (YES in step S802), the processing flow proceeds to step S803 in which the bookmark register unit 113 adds retrieval criteria to the screen control information. In step S804, the bookmark storage unit 105 stores the screen control information including added retrieval criteria. If the screen to be bookmarked is not the retrieval result screen (NO in step S802), the processing flow directly proceeds to step S804 in which the bookmark register unit 113 stores the displayed screen control information into the bookmark storage unit 105.

In step S805, the grammar updating unit 110 reads the speech recognition grammar from the grammar storage unit 106. In step S806, the grammar updating unit 110 updates the speech recognition grammar by adding grammar rules so that the speech recognition unit 109 can accept a registered bookmark name. In step S807, it is determined whether the screen to be bookmarked is a retrieval result screen. If the screen to be bookmarked is the retrieval result screen (YES in step S807), the processing flow proceeds to step S808 in which the grammar updating unit 110 updates the speech recognition grammar in order to accept the bookmark name and additional retrieval criteria which are input by continuous speaking. If the screen to be bookmarked is not a retrieval result screen (NO in step S807), the processing flow directly proceeds to step S809.

In step S809, the grammar storage unit 106 stores the speech recognition grammar updated in step S806 or step S808. Then, the bookmark registration processing is accomplished.

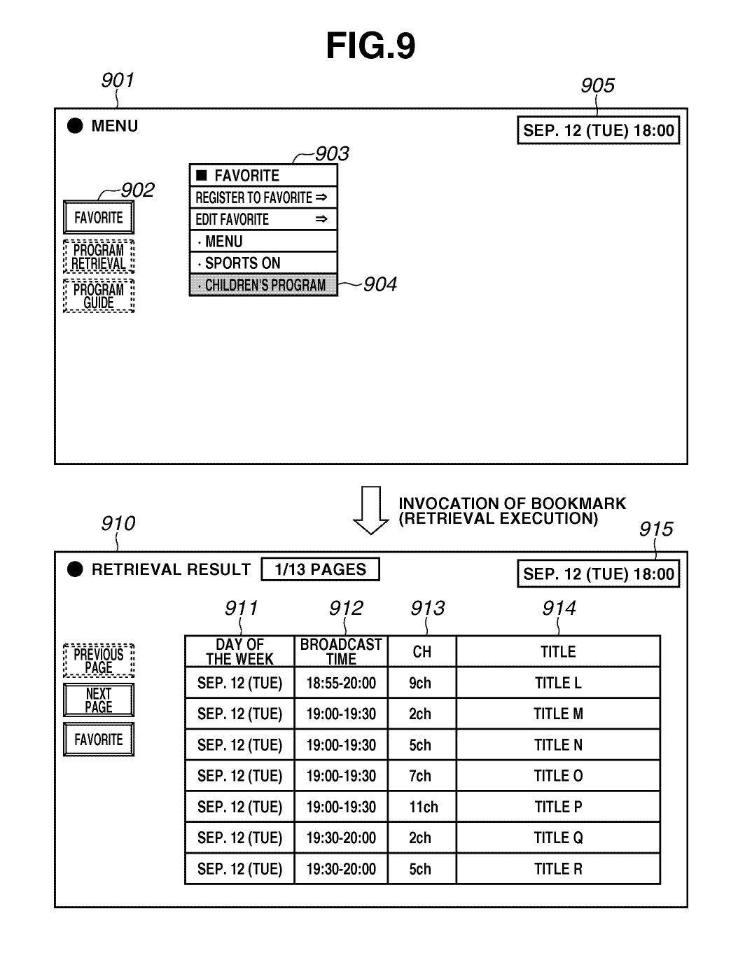

An exemplary operation for invoking a registered bookmark is described below. FIG. 9 illustrates an exemplary operation performed by the information processing apparatus according to the first exemplary embodiment that displays a startup menu screen enabling a user to invoke a registered bookmark.

When a user designates a bookmark name to be invoked via the input unit 101, the bookmark invocation unit 114 reads screen control information relating to the bookmark name designated by the user from the bookmark storage unit 105. Then, the display unit 102 displays a screen according to the read control information. A user can designate a bookmark name with a pointing device (e.g., a mouse or a digitizer) or by speech input.

A user can perform the bookmark name designation illustrated in FIG. 9 with a pointing device. If a user presses a favorite button 902 on a menu screen 901, the display unit 102 displays a favorite menu window 903. “CHILDREN'S PROGRAM” 904 is focused. If a user designates a bookmark “weekday night” in the favorite menu window 903, the display unit 102 displays a screen 910 corresponding to the bookmark “weekday night.”

As described previously, the information processing apparatus according to the first exemplary embodiment stores retrieval criteria as additional information of the screen control information when the retrieval result screen is bookmarked. When a user invokes a bookmark relating to a registered retrieval result screen, the display unit 102 displays a retrieval result obtained by retrieving the program information again using corresponding retrieval criteria.

According to the example illustrated in FIG. 9, if a user invokes the bookmark “weekday night”, the bookmark invocation unit 114 reads screen control information relating to the bookmark name “weekday night” from the bookmark storage unit 105. The information processing apparatus retrieves screen control information corresponding to the “weekday night” indicated in the row 607 of FIG. 6 using the retrieval criteria stored as additional information. More specifically, the retrieval unit 112 retrieves the program information stored in the program information storage unit 107 and displays a retrieval result of program information that accords with the retrieval criteria.

As described previously, the retrieval object in a retrieving operation includes only the program information of programs being currently broadcasted or to be later broadcasted. Accordingly, when a user invokes a bookmark of a registered retrieval result screen, the display unit 102 displays the latest program information that accords with the retrieval criteria.

The retrieval result display screen 410 of FIG. 4 illustrates an exemplary retrieval result obtained when a bookmark registration is performed at 17:00 on September 7 (as indicated in field 416)). The retrieval result display screen 910 of FIG. 9 illustrates an exemplary retrieval result obtained when a bookmark invocation operation is performed at 18:00 on September 12 (as indicated in the field 915).

A user is allowed to input a speech designating a bookmark name in a state where the menu screen 901 is displayed. If a speech input via the input unit 101 is detected, the speech recognition unit 109 recognizes the input speech according to the speech recognition grammar stored in the grammar storage unit 106. When the recognition result is a bookmark name, the bookmark invocation unit 114 reads screen control information corresponding to the recognition result from the bookmark storage unit 105 and updates the screen.

A user is allowed to input any additional retrieval criteria when invoking a bookmark of a retrieval result screen by speech input. For example, a user can continuously speak a bookmark name (e.g., “weekday night”) and additional retrieval criteria (e.g., “news at weekday night” or “sports at weekday night”). If the speech recognition unit 109 can accurately recognize the speech invoking “news at weekday night”, the display unit 102 displays a retrieval result obtained using the retrieval criteria corresponding to the bookmark registered in relation to the “weekday night” and additional retrieval criteria “news.” The speech recognition unit 109 analyzes the recognition result and determines the presence of any additional retrieval criteria.

For example, the publicly known morphological analysis technique is available for the analysis of recognition result. If the recognition result includes a bookmark name and any word designating retrieval criteria, it is determined that additional retrieval criteria may be present. Furthermore, if the speech recognition grammar with an attribute tag of each word is available, the speech recognition can be performed without using the morphological analysis technique. The tag can be used for the analysis on a recognition result.

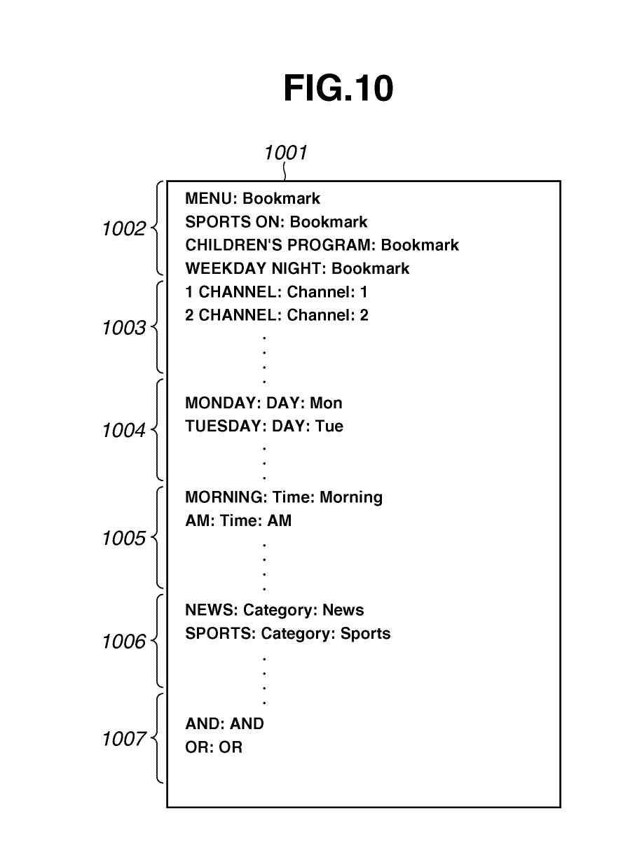

Any publicly known technique is usable for the addition of a tag and the analysis on tags in a recognition result. The addition of a tag is feasible when the grammar updating unit 110 updates the speech recognition grammar. FIG. 10 illustrates an exemplary tag 1001, which includes a word to be recognized and a tag paired with a break character “:.” The “Bookmark” tag added to a portion 1002 indicates that the attribute of a word is bookmark name. The “Channel” tag added to a portion 1003 indicates that the attribute of a word is channel. The numeral indicating a channel number, such as “1”, is added to the tag.

The “Day” tag added to a portion 1004 indicates that the attribute of a word is day of the week. The “Time” tag added to a portion 1005 indicates that the attribute of a word is time slot. The “Category” tag added to a portion 1006 indicates that the attribute of a word is category. Information indicating a type of the day, a type of the time slot, and a type of the category is added to the tag. The “AND” or “OR” tag added to a portion 1007 indicates a conjunction “and” or “or” between a bookmark name and additional retrieval criteria.

The presence of any additional retrieval criteria can be easily determined by analyzing the tag included in a recognition result. For example, a recognition result “Children's program:Bookmark and:AND morning:Time:Morning” indicates that the time slot “Morning” is added as additional retrieval criteria to the bookmark name “Children's program.” If inputting additional plural retrieval criteria is allowed, the recognition result may include “OR” or “AND” as a conjunction between the additional retrieval criteria, for example, as understood from an example “Children's program:Bookmark and:AND morning:Time:Morning or:OR night:Time:Night.” In this case, it is preferable to determine the rules of analysis beforehand.

For example, if the rules of analysis give priority to the conjunction “OR” between “OR” and “AND”, retrieval criteria “morning or night” have priority over another retrieval criteria “children's program and night” in the analysis according to the above-described example. Therefore, a retrieving operation of program information is performed using the retrieval criteria relating to the “children's program” and the retrieval criteria relating to the time slot “morning or night.” Similarly, a recognition result “children's program and weekday night” can be easily analyzed as the retrieval criteria satisfying both the retrieval criteria “weekday night” and the retrieval criteria “children's program.”

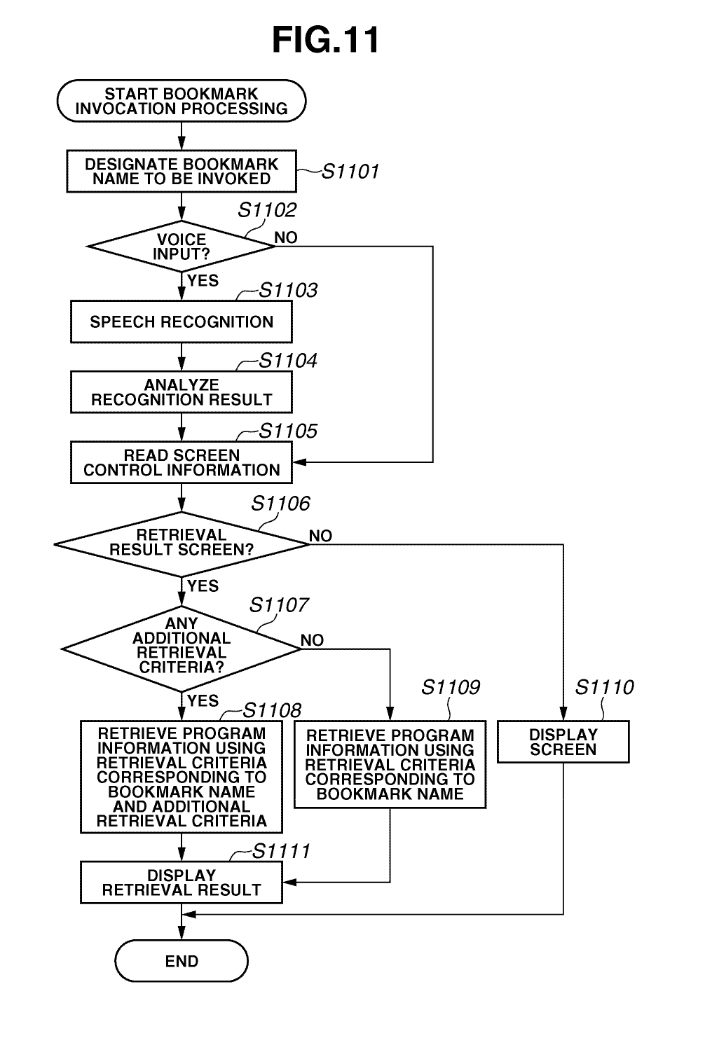

The above-described bookmark invocation processing is described below. FIG. 11 is a flowchart illustrating a processing procedure of a bookmark invocation operation. In step S1101, a user inputs a bookmark name to be invoked via the input unit 101. In step S1102, it is determined whether a bookmark name is designated by speech input. If a bookmark name is not designated by speech input (NO in step S1102), the processing flow proceeds to step S1105. If a bookmark name is designated by speech input (YES in step S1102), the processing flow proceeds to step S1103. In step S1103, the speech recognition unit 109 performs speech recognition processing on the input speech. In step S1104, the speech recognition unit 109 analyzes the recognition result and extracts a bookmark name from the recognition result. Furthermore, the speech recognition unit 109 determines the presence of any additional criteria.

In step S1105, the bookmark invocation unit 114 reads screen control information relating to the designated bookmark name from the bookmark storage unit 105. In step S1106, it is determined whether the designated bookmark name is related to a retrieval result screen. If the designated bookmark name is not related to the retrieval result screen (NO in step S1106), the processing flow proceeds to step S1110. In step S1110, the display unit 102 displays a screen according to the read screen control information. Then, the information processing apparatus terminates the bookmark invocation processing.

If the designated bookmark name is related to the retrieval result screen (YES in step S1106), the processing flow proceeds to step S1107. In step S1107, it is determined whether there is any additional retrieval criteria, referring to the recognition result analysis of step S1104. If there are any additional retrieval criteria other than a bookmark name (YES in step S1107), the processing flow proceeds to step S1108. If there are no additional retrieval criteria (NO in step S1107), the processing flow proceeds to step S1109. When a bookmark name is not designated by speech input in step S1101, there are no additional retrieval criteria. Thus, the determination of step S1107 becomes NO.

Next, the retrieval unit 112 retrieves program information that accords with the retrieval criteria from the program information storage unit 107. The retrieval criteria in step S1108 and the retrieval criteria in step S1109 are mutually different. In step S1109, the retrieval unit 112 performs retrieval processing using the retrieval criteria corresponding to the bookmark name.

In step S1108, the retrieval unit 112 performs retrieval processing using the retrieval criteria corresponding to the bookmark and the additional retrieval criteria. In step S1111, the display unit 102 displays a retrieval result obtained in step S1108 or S1109. Then, the information processing apparatus terminates the bookmark invocation processing.

As described above, when a user invokes a registered bookmark by speech input, the information processing apparatus according to the first exemplary embodiment can designate additional retrieval criteria together with the invoked bookmark. Thus, the first exemplary embodiment can reduce the number of user's operations and improve the usability.

In the above-described explanation, the grammar updating unit 110 updates the grammar in order to accept additional retrieval criteria. An exemplary embodiment may limit acceptable additional retrieval criteria to only the items not designated in the bookmark registration operation.

For example, according to the retrieval criteria input screen 401 of FIG. 4, retrieval criteria are already set with respect to the items of channel, day of the week, and time slot. Therefore, when the screen 410 is bookmarked, the information processing apparatus updates the speech recognition grammar so that only the undesignated item of category can be set as additional retrieval criteria.

Furthermore, according to the above-described embodiment, a user can input additional retrieval criteria together with an invoked bookmark only when a retrieval result screen is bookmarked. It is also useful to configure the retrieval criteria input screen so as to enable a user to input additional retrieval criteria.

For example, the retrieval criteria input screen 401 of FIG. 4 can be bookmarked with a bookmark name “usual criteria.” In this case, the grammar updating unit 110 updates the speech recognition grammar so that additional retrieval criteria can be input together with the bookmark name “usual criteria.” For example, the grammar updating unit 110 updates the speech recognition grammar in order to accept an input, such as “usual criteria and sports” or “usual criteria and channel 4”, which includes additional retrieval criteria in addition to the bookmark name.

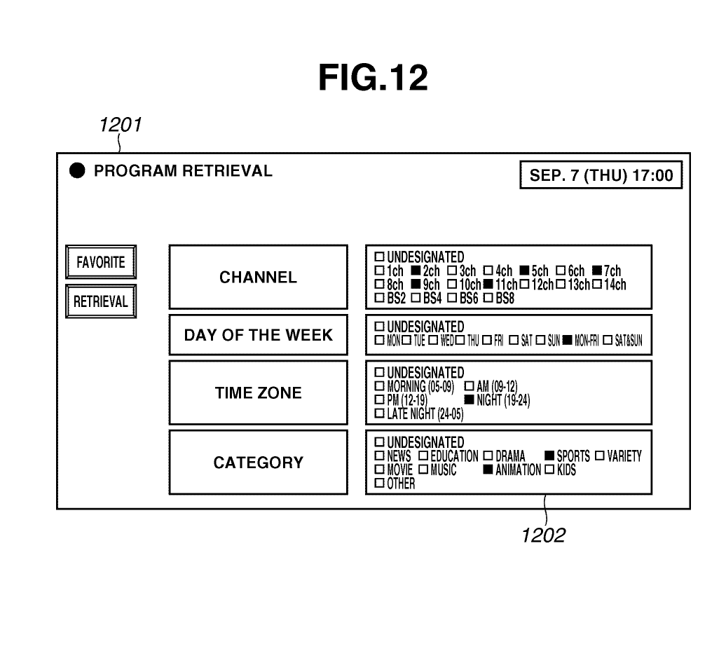

The information processing apparatus displays a screen including additional retrieval criteria in addition to the bookmark registration screen in response to a speech input invoking the additional retrieval criteria and the bookmark name. For example, if a speech input by a user is “usual criteria and sports and anime”, the bookmark invocation unit 114 displays a screen 1201 of FIG. 12. The screen 1201 includes a checkmark newly input to each check box of “sports” and “anime” in the category field 1202.

### Second Exemplary Embodiment

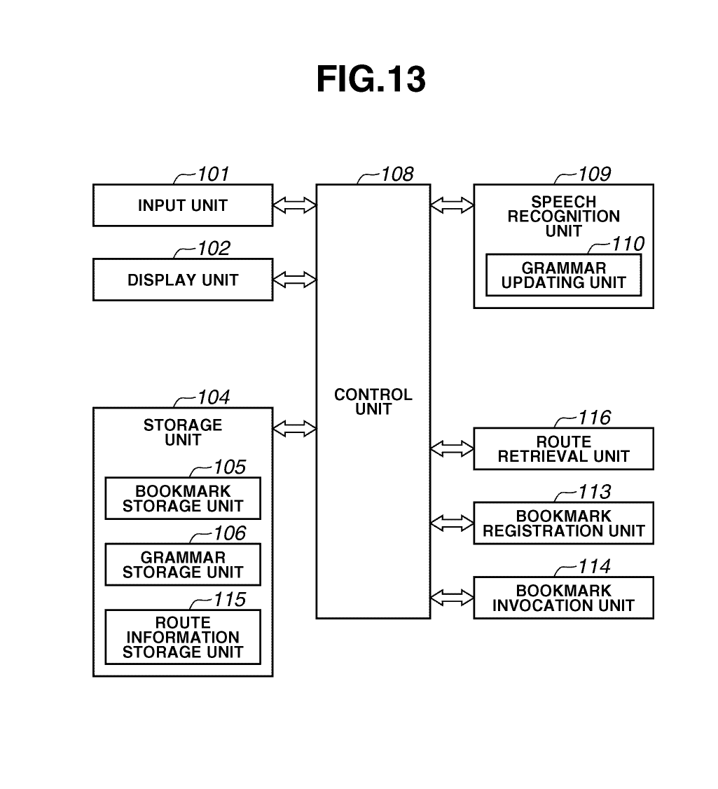

An information processing apparatus according to the second exemplary embodiment of the present invention performs route retrieval processing. FIG. 13 illustrates an information processing apparatus according to the second exemplary embodiment. The information processing apparatus according to the second exemplary embodiment includes an input unit 101, a display unit 102, a storage unit 104, a bookmark storage unit 105, a grammar storage unit 106, a control unit 108, a route information storage unit 115, a speech recognition unit 109, a grammar updating unit 110, a route retrieval unit 116, a bookmark register unit 113, and a bookmark invocation unit 114. In other words, the information processing apparatus according to the second exemplary embodiment includes the route information storage unit 115 and the route retrieval unit 116 which are not described in the first exemplary embodiment.

The route information storage unit 115 stores route information of an object to be retrieved by the retrieval unit 112. The route retrieval unit 116 retrieves route information that accords with the retrieval criteria designated by a user. The display unit 102 displays a retrieval result.

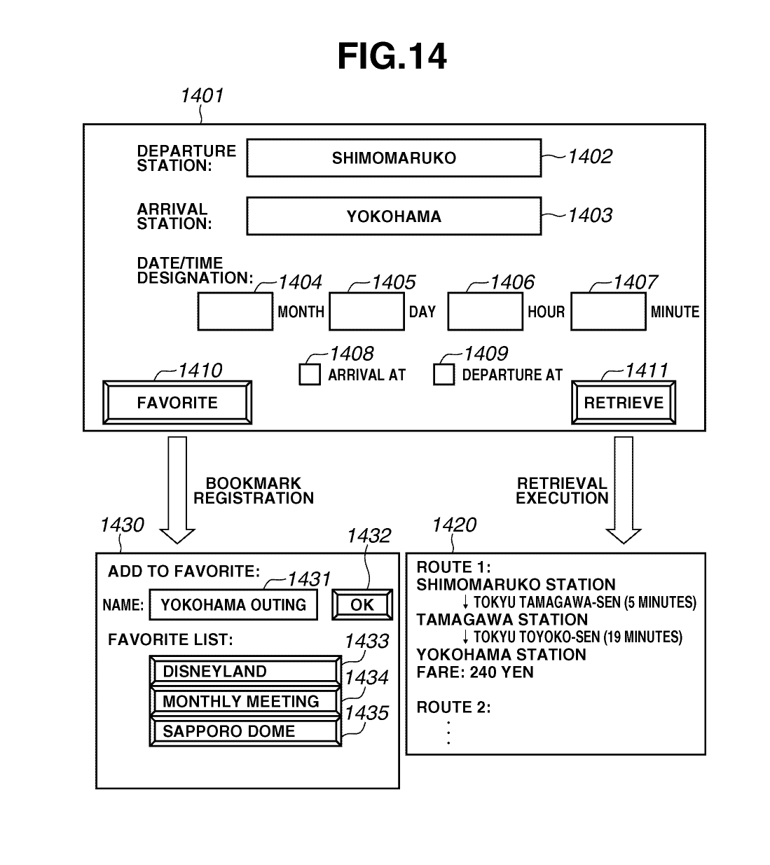

An exemplary operation performed by the information processing apparatus according to the second exemplary embodiment of the present invention is described below with reference to FIGS. 14 to 17. FIG. 14 illustrates a route information retrieval operation performed by the information processing apparatus according to the second exemplary embodiment. In FIG. 14, a screen 1401 enables a user to input retrieval criteria. A screen 1420 displays a retrieval result. A screen 1430 enables a user to register a bookmark.

The information processing apparatus according to the second exemplary embodiment retrieves a route between a departure station and an arrival station designated by a user, and displays a retrieval result including information relating to transfer station, total time, and fare in addition to optional information relating to departure and arrival date/time. A user can operate the keyboard of the input unit 101 to input station information (departure station 1402 and arrival station 1403) and date/time information (i.e., month 1404, day 1405, hour 1406, and minute 1407).

A user can input a check mark in a check box 1408 using a mouse or other pointing device to designate the arrival date/time. Similarly, a user can input a check mark in a check box 1409 to designate the departure date/time. The speech input is usable for the entry of each of retrieval criteria. If the input unit 101 detects any speech input, the speech recognition unit 109 performs speech recognition processing on the input speech according to the speech recognition grammar stored in the grammar storage unit 106. The display unit 102 changes a display screen based on the recognition result.

If a user presses a retrieval button 1411 after inputting retrieval criteria using the screen 1401, the route retrieval unit 116 retrieves route information from the route information storage unit 115 according to the input criteria. The display unit 102 displays a retrieval result on a screen 1420.

Next, an exemplary bookmark registration operation for the screen 1401 is described. If a user presses a favorite button 1410 after inputting retrieval criteria, the display unit 102 displays the screen 1430 that enables a user to register or invoke a bookmark. For example, the display unit 102 can superimpose the screen 1430 on the screen 1401 to be bookmarked so that a user can easily confirm the contents of the registered screen. A user can register a new bookmark by inputting a bookmark name into a field 1431 and pressing an OK button 1432.

In this case, the bookmark register unit 113 stores control information of the retrieval criteria input screen into the bookmark storage unit 105 in relation to the bookmark name input by a user. The grammar updating unit 110 updates the speech recognition grammar stored in the grammar storage unit 106 so that the speech recognition unit 109 can accept the speech input including the input bookmark name.

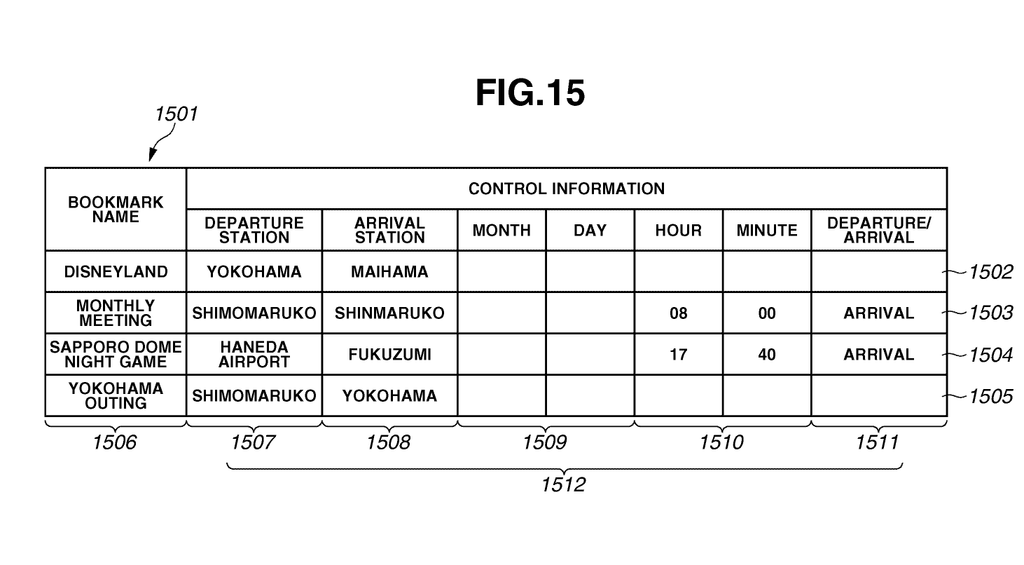

The information processing apparatus stores screen control information relating to the retrieval criteria input in the bookmark registration operation. FIG. 15 illustrates an example of the screen control information 1501 to be stored which includes a bookmark name 1506 and control information 1512 of the screen to be bookmarked. The control information 1512 includes departure station 1507, arrival station 1508, month and day 1509, hour and minute 1510 and departure/arrival 1511. The control information 1512 is retrieval criteria designated on the bookmarked screen. The bookmark name 1506 includes disneyland (row of 1502), monthly meeting (row of 1503), sapporo dome night game (row of 1504) and yokohama outing (row of 1505).

An exemplary bookmark registration operation includes processing for updating the speech recognition grammar. The grammar updating unit 110 reads the speech recognition grammar from the grammar storage unit 106 and updates the speech recognition grammar so that the speech recognition unit 109 can accept a bookmark name input by a user. For example, if a user registers a bookmark name “Yokohama outing”, the grammar updating unit 110 adds a new word “Yokohama outing” to the speech recognition grammar.

In addition, the grammar updating unit 110 updates the speech recognition grammar in order to accept a continuous speech input including a bookmark name and additional retrieval criteria. In this case, the additional retrieval criteria include any retrieval criteria which are not designated in the bookmark registration operation. For example, when the screen 1401 is bookmarked, additional retrieval criteria are month (1404), day (1405), time (1406), minute (1407), arrival (1408) or departure (1409) which are not yet designated on the screen 1401.

The grammar updating unit 110 updates the speech recognition grammar in order to accept various inputs relating to the bookmark name “Yokohama outing”, such as “Yokohama outing”, “Yokohama outing and departure at nine”, “Yokohama outing and September 16”, and “Yokohama outing and arrival at eight o'clock September 17.” The grammar storage unit 106 stores the updated speech recognition grammar.

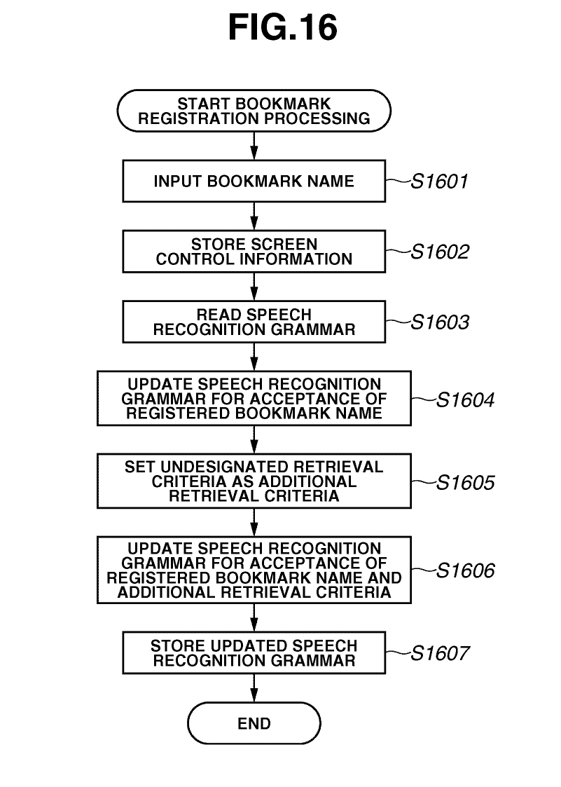

FIG. 16 is a flowchart illustrating a processing procedure of a bookmark registration operation performed by the information processing apparatus according to the second exemplary embodiment of the present invention. In step S1601, a user inputs a bookmark name via the input unit 101. In step S1602, the bookmark register unit 113 stores control information of a screen to be bookmarked in relation to the bookmark name into the bookmark storage unit 105. The screen control information is retrieval criteria designated on the screen to be bookmarked.

In step S1603, the grammar updating unit 110 reads the speech recognition grammar from the grammar storage unit 106. In step S1604, the grammar updating unit 110 updates the speech recognition grammar so that the speech recognition unit 109 can accept the registered bookmark name. In step S1605, the grammar updating unit 110 sets retrieval criteria undesignated on the registration screen as additional retrieval criteria.

In step S1606, the grammar updating unit 110 updates the speech recognition grammar in order to accept both the bookmark name and the additional retrieval criteria. In step S1607, the grammar storage unit 106 stores the updated speech recognition grammar. Then, the information processing apparatus terminates the bookmark registration processing.

Next, an exemplary operation for invoking a registered bookmark is described. A user can invoke a bookmark registered on the screen 1430 of FIG. 14 by pressing a desired one of bookmark buttons 1433 to 1435. In this case, the bookmark invocation unit 114 reads screen control information relating to the bookmark name designated by a user from the bookmark storage unit 105.

The display unit 102 displays a screen according to the readout control information. An information processing apparatus according to the second exemplary embodiment stores control information relating to retrieval criteria in the bookmark registration operation. The display unit 102 displays a screen that is restored according to the control information (retrieval criteria) stored in the bookmark registration operation.

An exemplary bookmark invocation operation can be performed in response to a speech input. A user can invoke a bookmark using any one of the retrieval criteria input screen (1401), the retrieval result display screen (1420), and bookmark registration/invocation screen (1430) illustrated in FIG. 14. The input unit 101 detects a speech input including a desired bookmark name input by a user. Then, the speech recognition unit 109 recognizes the input speech according to the speech recognition grammar stored in the grammar storage unit 106.

When the recognition result is a bookmark name, the bookmark invocation unit 114 reads screen control information relating to the recognition result from the bookmark storage unit 105. If a user inputs a speech invoking a bookmark, the route retrieval unit 116 retrieves route information with reference to the readout control information (the retrieval criteria in the registration operation). The display unit 102 displays a retrieval result.

In the information processing according to the second embodiments, the display contents are different in a case using a GUI and a case inputting a speech. When a user invokes a bookmark using a GUI, the information processing apparatus according to the second exemplary embodiment restores a criteria input screen. On the other hand, when a user inputs a speech invoking a bookmark, the information processing apparatus restores a retrieval result screen.

As described in the above bookmark registration processing, the speech recognition grammar stored in the grammar storage unit 106 can accept an input of additional retrieval criteria in addition to an input of a bookmark name. For example, an exemplary speech input “Yokohama outing and departure at nine” includes the bookmark name “Yokohama outing” and additional criteria “departure at nine.”

If the speech recognition unit 109 can accurately recognize the input speech, the information processing apparatus adds retrieval criteria “departure at nine” to the retrieval criteria corresponding to the registered bookmark “Yokohama outing” before executing the retrieval processing. The processing for analyzing a recognition result, such as a determination with respect to the presence of any additional retrieval criteria, is similar to that described in the first exemplary embodiment.

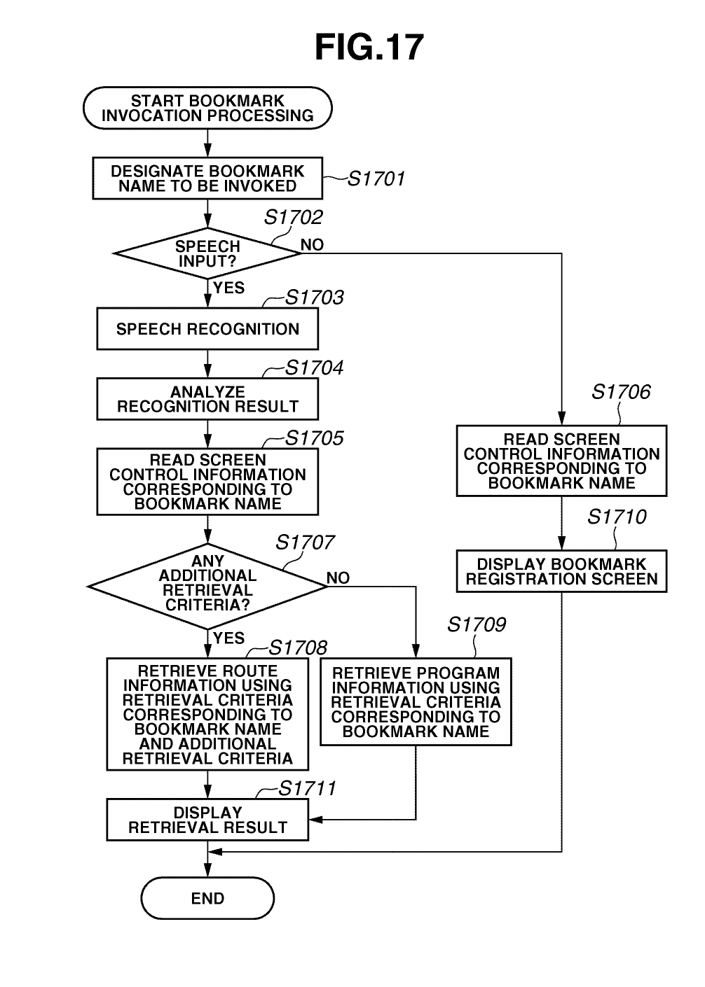

The above-described bookmark invocation processing is described below. FIG. 17 is a flowchart illustrating exemplary bookmark invocation processing performed by the information processing apparatus according to the second exemplary embodiment. In step S1701, a user inputs a bookmark name via the input unit 101. In step S1702, it is determined whether a bookmark name is designated by speech input. If a bookmark name is not input by speech (NO in step S1702), the processing flow proceeds to step S1706. In step S1706, the bookmark invocation unit 114 reads screen control information relating to the designated bookmark name from the bookmark storage unit 105.

In step S1710, the display unit 102 displays a screen used in the bookmark registration (i.e., the retrieval criteria input screen) based on the read control information. Then, the information processing apparatus terminates the bookmark invocation processing. If a user inputs a speech designating a bookmark name (YES in step S1702), the processing flow proceeds to step S1703. In step S1703, the speech recognition unit 109 performs speech recognition processing on the input speech. In step S1704, the speech recognition unit 109 analyzes the recognition result and extracts a bookmark name from the recognition result. Furthermore, the speech recognition unit 109 determines the presence of any additional criteria.

In step S1705, the bookmark invocation unit 114 reads screen control information relating to the designated bookmark name from the bookmark storage unit 105. In step S1707, it is determined whether the recognition result includes any additional retrieval criteria. If the recognition result includes any additional retrieval criteria (YES in step S1707), the processing flow proceeds to step S1708. If the recognition result includes no additional retrieval criteria (NO in step S1707), the processing flow proceeds to step S1709.

In steps S1708 and S1709, the route retrieval unit 116 retrieves route information that accords with the retrieval criteria from the route information storage unit 115. The retrieval criteria in step S1708 and the retrieval criteria in step 1709 are mutually different. In step 1709, the retrieval unit 112 performs retrieval processing using the retrieval criteria corresponding to the bookmark name. In step 1708, the retrieval unit 112 performs retrieval processing using the retrieval criteria corresponding to the bookmark and the additional retrieval criteria.

In step S1711, the display unit 102 displays a retrieval result obtained in step S1708 or S1709. Then, the information processing apparatus terminates the bookmark invocation processing. As described above, when a user inputs a speech invoking a registered bookmark, the information processing apparatus according to the second exemplary embodiment can designate additional retrieval criteria upon invoking a bookmark and therefore can reduce the number of user's operations and improve the usability.

### Third Exemplary Embodiment

The information processing apparatus according to the first or second exemplary embodiment determines additional retrieval criteria that can be input together with a bookmark name in a bookmark registration operation including update of the speech recognition grammar. The information processing apparatus according to the third exemplary embodiment enables a user to explicitly designate additional retrieval criteria accepted by the speech recognition unit. The information processing apparatus according to the third exemplary embodiment is similar in structural arrangement to the information processing apparatus according to the second exemplary embodiment.

The information processing apparatus according to the third exemplary embodiment updates the speech recognition grammar so that retrieval criteria focused on a screen to be bookmarked can be input as additional retrieval criteria together with a bookmark name. A user can explicitly designate additional retrieval criteria to be input together with a bookmark by focusing a pointer on desired retrieval criteria in the registration of the bookmark.

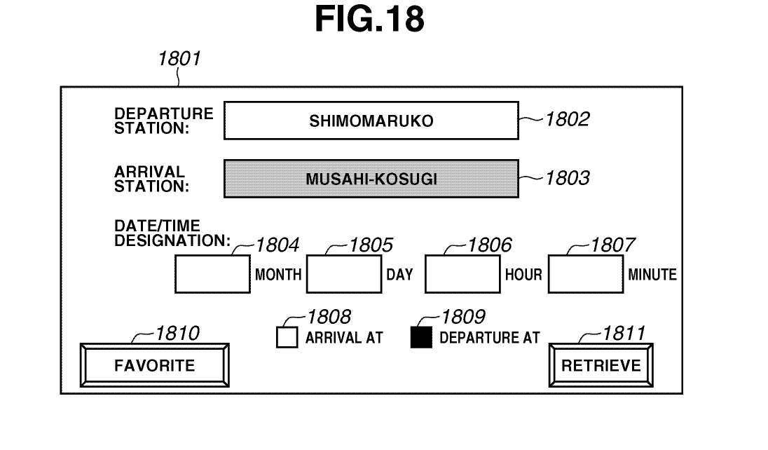

FIG. 18 illustrates an exemplary operation performed by the information processing apparatus according to the third exemplary embodiment. According to retrieval criteria input on a screen 1801, departure station (1802) is Shimomaruko, arrival station (1803) is Musashi-Kosugi, and date/time designation (1806, 1807, and 1809) is departure at 9 o'clock. In this state, the retrieval criteria being focused (highlighted) is the arrival station (1803). If a user registers this screen with a bookmark name “outing at nine”, the information processing apparatus updates the speech recognition grammar in order to accept the focused retrieval criteria (arrival station) as additional retrieval criteria together with the bookmark name “outing at nine.” A processing procedure of the bookmark registration operation according to the third exemplary embodiment is similar to that described in the second exemplary embodiment.

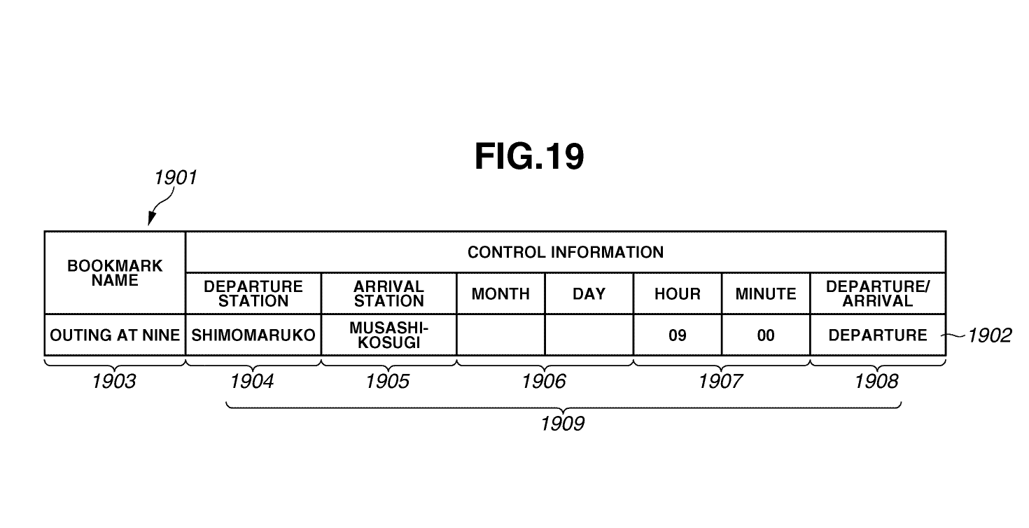

Furthermore, the information processing apparatus relates the bookmark name “outing at nine” with retrieval criteria “departure station: Shimomaruko, arrival station: Musashi-Kosugi, departure at nine o'clock” and stores the related information as screen control information into the bookmark storage unit 105. FIG. 19 illustrates exemplary screen control information stored in the bookmark storage unit 105.

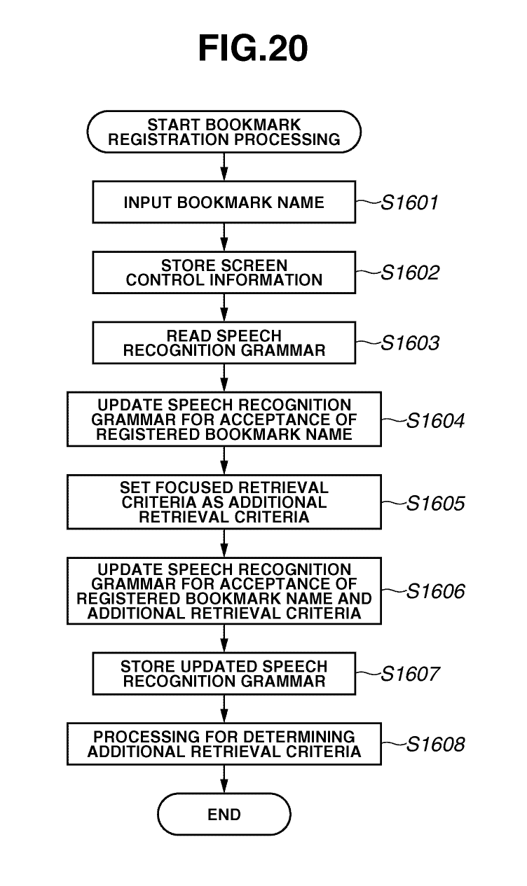

FIG. 20 is a flowchart illustrating a processing procedure of a bookmark registration operation performed by the information processing apparatus according to the third exemplary embodiment. The processing of FIG. 20 includes step S1608 (processing for determining additional retrieval criteria) which is not described in the bookmark registration processing (FIG. 16) according to the second exemplary embodiment. The information processing apparatus according to the third exemplary embodiment performs bookmark invocation processing similar to the processing described in the second exemplary embodiment according to the flowchart illustrated in FIG. 17.

If a user inputs a speech invoking the bookmark name “outing at nine” (YES in steps S1701 and S1702), the speech recognition unit 109 recognizes the input speech and analyzes the recognition result (steps S1703 and S1704). In step S1705, the bookmark invocation unit 114 reads screen control information relating to the bookmark name “outing at nine” from the bookmark storage unit 105, based on the analysis of the recognition result.

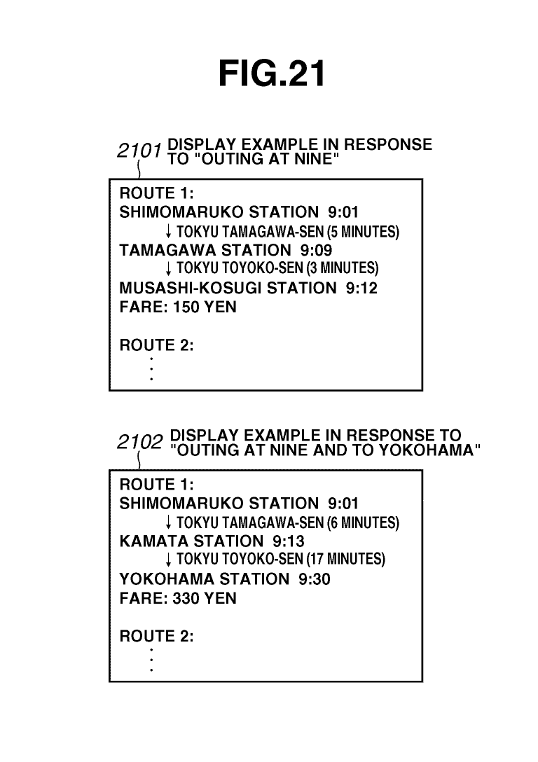

As the input includes no additional retrieval criteria (NO in step S1707), the processing flow proceeds to step S1709 in which the route retrieval unit 116 retrieves route information that accords with the retrieval criteria included in the read control information (1909 of FIG. 19). In step S1711, the display unit 102 displays a retrieval result. FIG. 21 illustrates a display example 2101 for the bookmark name “outing at nine.”

If a user invokes the bookmark name and additional retrieval criteria, such as “outing at nine and to Yokohama”, the determination in step S1707 is YES. The processing flow proceeds to step S1708 in which the route retrieval unit 116 retrieves route information that accords with the retrieval criteria including the bookmark name “outing at nine” and the additional retrieval criteria “to Yokohama.”

In this case, if retrieval criteria belonging to the same item are set in both the retrieval criteria related to the bookmark name and the input additional retrieval criteria, the route retrieval unit 116 gives the priority to the additional retrieval criteria. According to this example, the route retrieval unit 116 changes “arrival station: Musashi-Kosugi” in the retrieval criteria relating to the bookmark name “outing at nine” to additional retrieval criteria “arrival station: Yokohama” before performing the route retrieval. FIG. 21 illustrates a display example 2102 of a retrieval result.

According to the above-described third exemplary embodiment, only one of retrieval criteria is focused in a bookmark registration. However, according to another exemplary embodiment of the present invention, a plurality of retrieval criteria can be focused. For example, when a user registers a bookmark focused on a departure station and an arrival station, the grammar updating unit 110 updates the speech recognition grammar so that additional retrieval criteria including at least one of the departure station and the arrival station can be accepted together with a bookmark name.

As described above, when a user registers a bookmark, the information processing apparatus according to the third exemplary embodiment enables a user to explicitly designate additional retrieval criteria to be input together with an invoked bookmark. Thus, the above-described third exemplary embodiment can improve the usability.

### Fourth Exemplary Embodiment

The information processing apparatus according to the third exemplary embodiment updates the speech recognition grammar in order to accept focused retrieval criteria as additional retrieval criteria together with a bookmark name. However, it is also useful to simply store a focus position.

For example, according to an exemplary bookmark registration illustrated in FIG. 18, the departure station is Shimomaruko. The date/time designation is “departure at” 9:00. The arrival station is highlighted (focused). According to this arrangement, when a user designates a bookmark, the bookmark designation screen displays the arrival station in a focused state. Thus, the fourth exemplary embodiment enables a user to easily input a name of the arrival station and can improve the usability.

Furthermore, software program code for realizing the functions of the above-described exemplary embodiments can be supplied to a system or an apparatus including various devices. A computer (or CPU or micro-processing unit (MPU)) in the system or the apparatus can execute the program to operate the devices to realize the functions of the above-described exemplary embodiments.

Accordingly, the present invention encompasses the program code installable on a computer when the functions or processes of the exemplary embodiments can be realized by the computer. In this case, the program code itself can realize the functions of the exemplary embodiments. The equivalents of programs can be used if they possess comparable functions. Furthermore, the present invention encompasses supplying program code to a computer with a storage (or recording) medium storing the program code.

In this case, the type of program can be any one of object code, interpreter program, and OS script data. A storage medium supplying the program can be selected from any one of a Floppy® disk, a hard disk, an optical disk, a magneto-optical (MO) disk, a compact disk-ROM (CD-ROM), a CD-recordable (CD-R), a CD-rewritable (CD-RW), a magnetic tape, a nonvolatile memory card, a ROM, and a DVD (DVD-ROM, DVD-R).

Moreover, an operating system (OS) or other application software running on a computer can execute part or all of actual processing based on instructions of the programs. Additionally, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-328206 filed Dec. 5, 2006, which is hereby incorporated by reference herein in its entirety.

What is claimed is:

1. An information processing apparatus comprising:
a setting unit configured to set first retrieval criteria including a plurality of items;
a storage unit configured to store a designated word in relation to the first retrieval criteria set by the setting unit, into a memory; and
a retrieval unit configured to receive a speech input including the word stored in relation to the first retrieval criteria and second retrieval criteria different from the first retrieval criteria, and retrieve data based on both the first retrieval criteria and the second retrieval criteria.

2. The information processing apparatus according to claim 1, further comprising:
a speech recognition unit configured to perform speech recognition on a received speech using a speech recognition grammar; and
an updating unit configured to update the speech recognition grammar so that the speech recognition can be performed on the speech input including the word corresponding to the first retrieval criteria and the second retrieval criteria,
wherein the retrieval unit obtains the first retrieval criteria and the second retrieval criteria from a result obtained by the speech recognition unit in response to reception of the speech input.

3. The information processing apparatus according to claim 2, wherein the updating unit updates the speech recognition grammar while the second retrieval criteria includes retrieval criteria that can be set to an item not being set to the first retrieval criteria among the plurality of items.

4. The information processing apparatus according to claim 2, further comprising:
a display control unit configured to display the plurality of items on a screen; and
a focus control unit configured to focus the display of the screen on at least one of the plurality of items,
wherein the updating unit updates the speech recognition grammar while the second retrieval criteria includes retrieval criteria that can be set to the at least one of the plurality of items.

5. An information processing apparatus comprising:
a first display control unit configured to display on a screen display data that enable a user to set retrieval criteria including a plurality of items;
a focus control unit configured to focus the display of the screen on at least one of the plurality of items;
a setting unit configured to set the retrieval criteria including the plurality of items;
a register unit configured to register a designated word in relation to the retrieval criteria set by the setting unit, wherein the register unit relates the word with an item focused by the focus control unit;
a receiving unit configured to receive designation of the word; and
a second display control unit configured to display on a screen display data setting the retrieval criteria related to the word in response to the designation of the word received by the receiving unit, in a condition where an item relating to the word registered by the register unit is focused.

6. A method comprising:
setting first retrieval criteria including a plurality of items;
storing a designated word in relation to the set first retrieval criteria into a memory; and
receiving a speech input including the word stored in relation to the first retrieval criteria and second retrieval criteria different from the first retrieval criteria and retrieving data based on both the first retrieval criteria and the second retrieval criteria.

7. The method according to claim 6, further comprising:
performing speech recognition on a received speech using a speech recognition grammar; and
updating the speech recognition grammar so that the speech recognition can be performed on the speech input including the word corresponding to the first retrieval criteria and the second retrieval criteria,
wherein the first retrieval criteria and the second retrieval criteria are obtained from a result of the speech recognition in response to reception of the speech input.

8. The method according to claim 7, wherein the speech recognition grammar is updated while the second retrieval criteria includes retrieval criteria that can be set to an item not being set to the first retrieval criteria among the plurality of items.

9. The method according to claim 7, further comprising:
displaying the plurality of items on a screen; and
focusing the display of the screen on at least one of the plurality of items,
wherein the speech recognition grammar is updated while the second retrieval criteria includes retrieval criteria that can be set to the at least one of the plurality of items.

10. A method comprising:
displaying on a screen display data that enable a user to set retrieval criteria including a plurality of items;
focusing the display of the screen on at least one of the plurality of items;
setting the retrieval criteria including the plurality of items;
registering a designated word in relation to the retrieval criteria, wherein the word is related with a focused item;
receiving designation of the word; and
displaying on a screen display data setting the retrieval criteria related to the word in response to the designation of the word, in a condition where an item relating to the registered word is focused.
